(19) United States
(12) Patent Application Publication
(10) Pub. No.: US 2003/0103472 A1
(43) Pub. Date: Jun. 5, 2003

(54) RF wireless access control for locking system

(76) Inventors: Ronald Taylor, Wheaton, IL (US); James F. Wiemeyer, Homer Glen, IL (US); Eric V. Gonzales, Aurora, IL (US)

Correspondence Address: McAndrews, Held & Malloy, Ltd., 500 W. Madison Street, 34th Floor, Chicago, IL, 60661, US

(21) Appl. No.: 10/262,077

(22) Filed: Sep. 30, 2002

Related U.S. Application Data
(60) Provisional application No. 60/326,338, filed on Sep. 30, 2001.
(60) Provisional application No. 60/326,299, filed on Sep. 30, 2001.
(60) Provisional application No. 60/326,201, filed on Sep. 30, 2001.
(60) Provisional application No. 60/326,316, filed on Sep. 30, 2001.
(60) Provisional application No. 60/326,298, filed on Sep. 30, 2001.
(60) Provisional application No. 60/326,179, filed on Sep. 30, 2001.
(60) Provisional application No. 60/326,296, filed on Sep. 30, 2001.
(60) Provisional application No. 60/326,294, filed on Sep. 30, 2001.
(60) Provisional application No. 60/326,295, filed on Sep. 30, 2001.

(51) Int. Cl. H04B 7/185; H04Q 7/00

(52) U.S. Cl. 370/318; 370/328

(57) ABSTRACT

In wireless access control system, a method and system for minimizing power consumption at Wireless Access Point Modules WAPMs while maintain communication between said WAPMs and at least one Wireless Panel Interface Module (WPIM). When the WAPMs are not actively in use, the WAPMs minimize the power supplied to the wireless transceiver and enter a sleep state. While in the sleep state, the WAPMs periodically transmit a heartbeat signal to the WPIMs to confirm that the communication link between the WAPMs and the WPIMs is still valid. Additionally, an emergency beacon may be transmitted to the WAPMs to unlock the WAPMs to provide quick egress.

### RELATED APPLICATIONS

The present application claims priority to the following provisional applications all filed Sep. 30, 2001: Application No. 60/326,338, entitled “RF Channel Linking Method and System”; Application No. 60/326,299, entitled “Energy Saving Motor-Driven Locking Subsystem”; Application No. 60/326,201 entitled “Cardholder Interface for an Access Control System”; Application No. 60/326,316, entitled “System Management Interface for Radio Frequency Access Control”; Application No. 60/326,298 entitled “Power Management for Locking System”; Application No. 60/326,179, entitled “General Access Control Features for a RF Access Control System”; Application No. 60/326,296, entitled “RF Wireless Access Control for Locking System”; Application No. 60/326,294, entitled “Maintenance/Trouble Signals for a RF Wireless Locking System”; and Application No. 60/326,295, entitled “RF Dynamic Channel Switching Method.”

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The preferred embodiments of the present invention relate to an RF access control system for controlling access to an access point. More specifically, the preferred embodiments of the present invention relates to a RF wireless access control system with improved communication between elements of the system, improved power utilization, and an emergency communication system.

A wireless access control system may provide several advantages over a traditional, wire-based access control system. In a traditional, wired access control system, each access point, such as a door, for example, is equipped with a locking module to secure the access point. Each locking module is in turn directly wired to a remote access control module. The access control module is typically a database that compares a signal received from the locking module to a stored signal in the database in order to determine an access decision for that locking module. Once the access decision has been determined by the access control module, the decision is relayed to the locking module through the wired connection.

The use of wired connections between the access control module and the locking module necessitates a large investment of time and expense in purchasing and installing the wires. For example, for larger installations, literally miles of wires must be purchased and installed. An access control system that minimizes the time and expense of the installation would be highly desirable.

Additionally, wire-based systems are prone to reliability and security failures. For example, a wire may short out or be cut and the locking module connected to the access control module by the wire may no longer be under the control of the access control module. If a wire connection is cut or goes, the only alternative is to repair the faulty location (which may not be feasible) or run new wire all the way from the access control module to the locking module, thus incurring additional time and expense. Conversely, an access control system that provides several available communication channels between the locking module and the access control module so that if one communication channel is not usable, communication may proceed on one of the other communication channels, would also be highly desirable, especially if such an access control system did not add additional costs to install the additional communication channels.

A wireless access system providing a wireless communication channel between the locking module and the access control module may provide many benefits over the standard, wire-based access control system. Such a wireless access system is typically less expensive to install and maintain due to the minimization of wire and the necessary installation time. Additionally, such a system is typically more secure because communication between the locking module and the access control module is more robust that a single wire.

However, one difficulty often encountered in installing and maintaining such a wireless access system is maintaining communication among the elements of the system while minimizing power consumption. A wireless access system that maintained reliable communication links while minimizing power consumption would be highly desirable.

Additionally, a wireless access system that provided an emergency egress feature would be highly desirable.

### BRIEF SUMMARY OF THE INVENTION

A wireless access control system that minimizes power consumption at Wireless Access Point Modules WAPMs while maintaining communication between said WAPMs and at least one Wireless Panel Interface Module (WPIM) is provided. When the WAPMs are not actively in use, the WAPMs minimize the power supplied to the wireless transceiver and enter a sleep state. While in the sleep state, the WAPMs periodically transmit a heartbeat signal to the WPIMs to confirm that the communication link between the WAPMs and the WPIMs is still valid. Additionally, an emergency beacon may be transmitted to the WAPMs to unlock the WAPMs to provide quick egress.

### BRIEF DESCRIPTION OF SEVERAL VIEWS OF THE DRAWINGS

FIG. 1 illustrates a block diagram of the components of a wireless access system according to a preferred embodiment of the present invention.

FIG. 2 illustrates a block diagram of the components of an expanded wireless access system according to a preferred embodiment of the present invention.

FIG. 3 illustrates a Wireless Access Point Module (WAPM) for the wireless access system of FIG. 1 according to a preferred embodiment of the present invention.

FIG. 4 illustrates a WPIM for the wireless access system of FIG. 1 according to a preferred embodiment of the present invention.

### DETAILED DESCRIPTION OF THE INVENTION

The present application is directed toward a portion of a wireless access system. Additional disclosure of the wireless access system may be found in the following co-filed applications which are hereby incorporated by reference in their entirety: Application No. ______, entitled “RF Channel Linking Method and System” filed Sep. 30, 2002; Application No. ______, entitled “Energy Saving Motor-Driven Locking Subsystem” filed Sep. 30, 2002; Application No. ______ entitled “Cardholder Interface for an Access Control System” filed Sep. 30, 2002; Application No. ______, entitled “System Management Interface for Radio Frequency Access Control” filed Sep. 30, 2002; Application No. ______ entitled “Power Management for Locking System” filed Sep. 30, 2002; Application No. ______, entitled “General Access Control Features for a RF Access Control System” filed Sep. 30, 2002; Application No. ______, entitled “RF Wireless Access Control for Locking System” filed Sep. 30, 2002; Application No. ______, entitled “Maintenance/Trouble Signals for a RF Wireless Locking System” filed Sep. 30, 2002; and Application No. ______, entitled “RF Dynamic Channel Switching Method” filed Sep. 30, 2002.

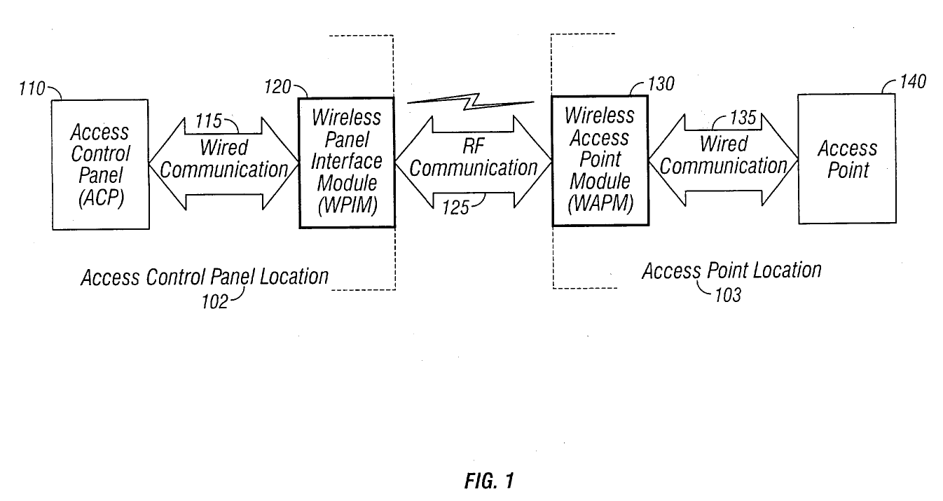

FIG. 1 illustrates a block diagram of the components of a wireless access system 100 according to a preferred embodiment of the present invention. The wireless access system 100 includes several components installed at one of two generalized locations, an access control panel location 102 and an access point location 103. The access control panel location 102 includes an access control panel (ACP) 110 and a Wireless Panel Interface Module (WPIM) 120. The access point location 103 includes a Wireless Access Point Module (WAPM) 130 and an access point 140. The access control panel 110 communicates with the WPIM 120 through a bi-directional wired communication link 115. The WPIM 120 communicates with the WAPM 130 through a bi-directional RF communication link 125. The WAPM 130 communicates with the access point 140 through a bi-directional wired communication link 135. The access point 140 is preferably a door or portal, but may be a container, secure location, or a device of some kind, for example.

In operation, an access signal is read at the access point 140. The access signal may be a signal from an access card, for example, a magnetic stripe or Wiegand access card. Alternatively, the access signal may be a biometric or a numeric sequence or some other access signal. The access signal is relayed from the access point 140 to the WAPM 130 through the wired communication link 135. As further described below, the access point 140 may be integrated into the WAPM 130 to form a single component or may be a separate component wired to the WAPM 130.

Once the WAPM 130 receives the access signal from the access point 140, the WAPM 130 transmits the access signal to the WPIM 120 over the RF communication link 125. The WPIM 120 receives the access signal and relays the access signal to the ACP 110 over the wired communication link 115.

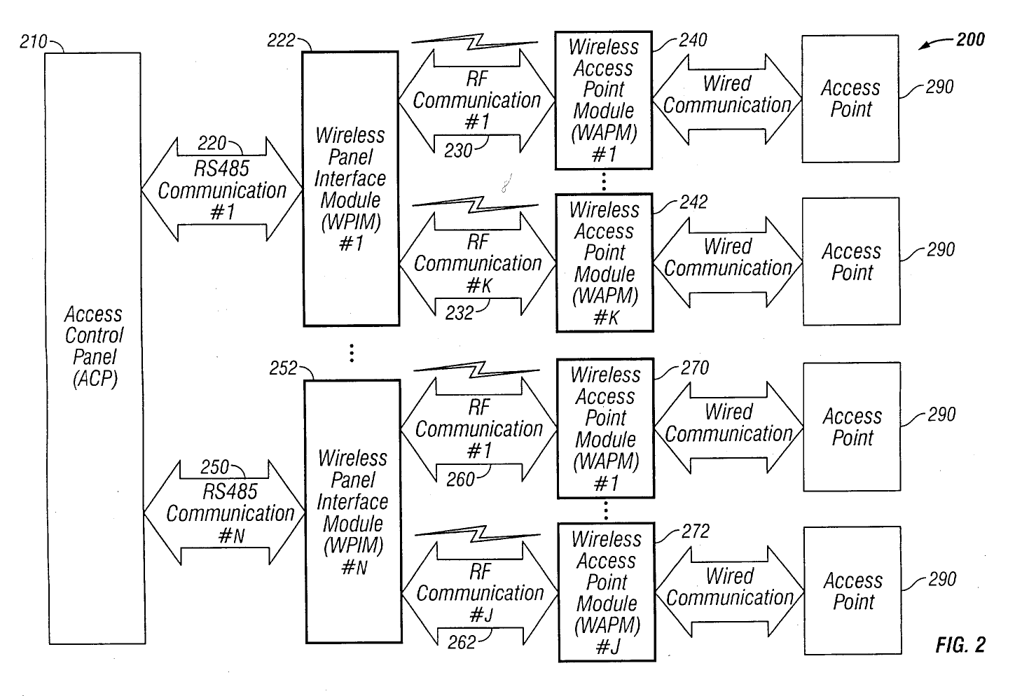

FIG. 2 illustrates a block diagram of the components of an expanded wireless access system 200 according to a preferred embodiment of the present invention. The expanded wireless access system 200 includes an ACP 210, multiple wired communication links 220, 222 numbered 1 to N, multiple WPIMs 222, 252 numbered 1 to N, multiple RF communication links 230, 2323, 260, 262 numbered 1 to K and 1 to J, and multiple WAPMs 240, 242, 270, 272 numbered 1 to K and 1 to J. The expanded wireless access system 200 is similar to the access system 100 of FIG. 1, and includes the same components, but has been expanded to include multiple access points, WAPMs, and WPIMs.

In the expanded wireless access system 200, a single ACP 210 communicates with a number N of WPIMs 222, 252 over a number N of wired communication links 220, 250. That is, the ACP supports communication with and provides access decisions for plurality of WPIMs 222, 252. Each WPIM 222, 252 may in turn support a plurality of WAPMs 240, 242, 270, 272 each WAPM positioned at a single access point. For example, WPIM #1 communicates with a number K of WAPMs 240, 242 over a number K of RF communication links 230, 232. Additionally, WPIM #N communicates with a number J of WAPMs 270, 272 over a number J of RF communication links 260, 262.

In a preferred embodiment, the ACP 210 supports three WPIMs and each PIM can support up to six WAPMs. However, as more advanced and configurable systems are developed, the total numbers of WPIMs and WAPMs supported is expected to rise. Additionally, the N wired communication links 220, 250 are illustrated as the preferred embodiment of RS485 communication links. Alternatively, other well-known communication protocols may be employed.

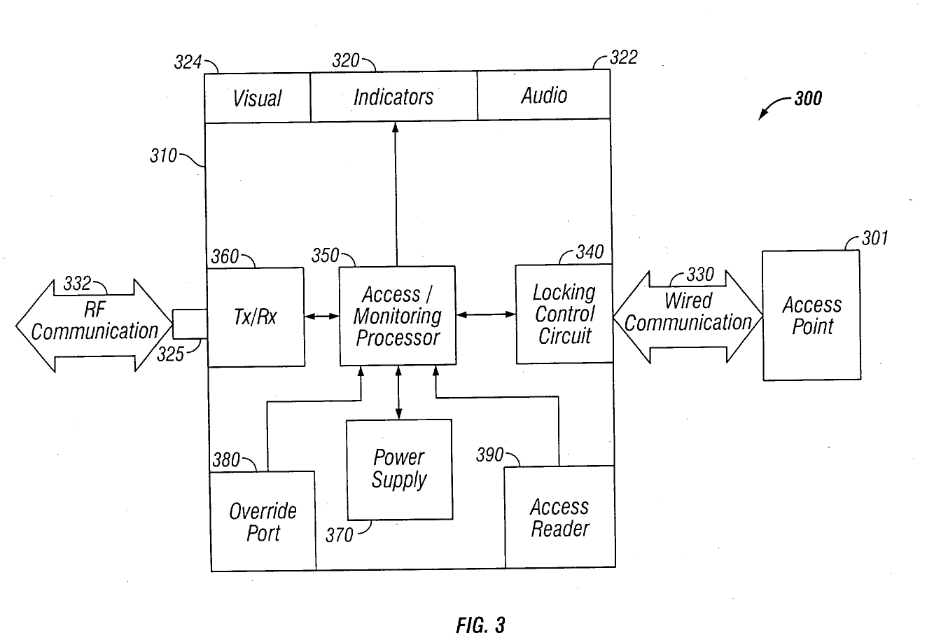

FIG. 3 illustrates a Wireless Access Point Module (WAPM) 300 for the wireless access system 100 of FIG. 1 according to a preferred embodiment of the present invention. The WAPM 300 includes a housing 310, indicators 320, a wired communication link 330, a RF communication link 332, and an antenna 325. The housing 310 includes a locking control circuit 340, an access/monitoring processor 350, a transceiver 360, a power supply 370, an override port 380, and an access reader 390. The indicators 320 may include one or both of an audio indicator 322 and a visual indicator 324. An access point 301 is also shown in FIG. 3.

The power supply 370 provides power to all of the other systems of the housing 310, including the transceiver 360, the locking control circuit 340, and the access/monitoring processor 350. The power supply 370 may be an internal battery or other internal type of power supply. Alternatively, an external power supply may be employed. The transceiver 360 is coupled to the antenna 325 to allow signals to be sent and received from the housing 310 to an external point such as a WPIM through the RF communication link 332. The locking control circuit 340 is coupled to the access point 301 and provides locking control signals to the access point 301 through the wired communication link 330. Additionally, the locking control circuit 340 may receive feedback from the access point 301 through the wired communication link 330, for example to verify that the access point is secured. The access reader 390 receives access signals such as from an integrated card reader or other access device, for example. The indicators 320 may provide a visual or audio indication, for example of the state of the WAPM 300 or that an access signal has been read by the access reader 390.

In operation, an access signal may be received from the access reader 390. The access signal is then relayed to the access/monitoring processor 350. The access/monitoring processor 350 then sends the access signal to the transceiver 360. The transceiver 360 transmits the access signal to WPIM 120 of FIG. 1 that is interfaced to the ACP 110. As further explained below, the ACP 110 includes a database of authorized access signals. If the access signal received from the WAPM 300 is determined by the ACP 110 to be a signal corresponding to an authorized user, a confirmation is transmitted from the ACP 110 to the WPIM 120 and then to the transceiver 360 of the WAPM 300. The confirmation is relayed from the transceiver 360 to the access/monitoring processor 350. The access/monitoring processor 350 then sends a locking control signal to the locking control unit 340. When the locking control unit 340 receives the locking control signal, the locking control unit 340 activates the access point 301 through the wired communication link 330 to allow access. The indicators 320 may be a visual or audible signal that the housing 310 has read an access signal, transmitted the access signal to the remote access control panel, received a confirmation, or activated the locking member, for example.

The WAPM 300 may include several variations. For example, the WAPM may be an Integrated Reader Lock (IRL), a Wireless Reader Interface (WRI), a Wireless Integrated Strike Interface (WISI), a Wireless Universal Strike Interface (WUSI), or a Wireless Portable Reader (WPR). The IRL includes an integrated access reader and lock. That is, the WAPM is similar to FIG. 3, but includes the access point as part of the housing. The WRI is similar to the WAPM, but does not include an integrated access reader and instead receives signals from a third party access reader. The WISI includes an integrated reader and lock and is mounted directly into the strike of the access point, such as a door, for example. The WUSI is similar to the WISI, but does not include an integrated reader and lock and may instead be connected to a third party reader and/or lock. The WPR is a portable reader that may be taken to a remote location and determine access decisions at the remote location, for example, for security checks or badging checks.

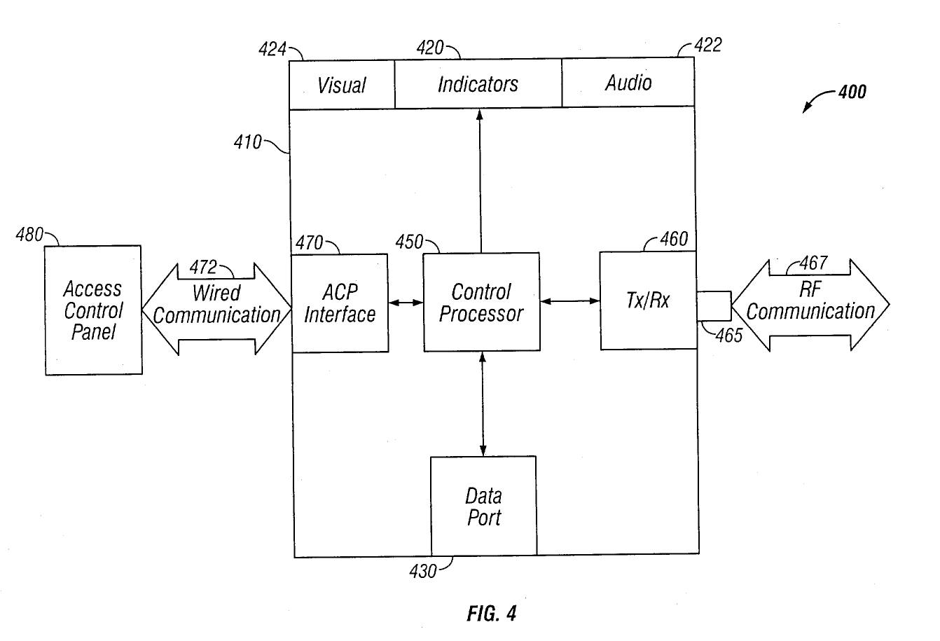

FIG. 4 illustrates a WPIM 400 for the wireless access system 100 of FIG. 1 according to a preferred embodiment of the present invention. The WPIM 400 includes a housing 410, an antenna 465, and indicators 420. The housing 410 includes a data port 430. a control processor 450, a transceiver 460 and an ACP interface 470. FIG. 4 also shows an RF communication link 467, a wired communication link 472, and an ACP 480.

Power is typically supplied to the WPIM via an AC power supply or through the wired communication 472. The transceiver 460 is coupled to the antenna 465 to allow signals to be sent and received from the housing 410 to an external point such as a WAPM through the RF communication link 467. The ACP 480 is coupled to the WPIM 400 through the wired communication link 472. The data port 430 is coupled to the control processor 450 to allow an external user such as a technician, for example, to interface with the control processor. The indicators 420 may provide a visual or audio indication, for example of the state of the WPIM 400 or that an access signal has been passed to the ACP 480 or an authorization passed to a WAPM 300.

In operation, the WPIM 400 receives access signals from the WAPM 300 through the antenna 465 and transceiver 460. The WPIM relays the access signals to the ACP 480 for decision making. Once the access decision has been made, the ACP 480 transmits the access decision through the wired communication link 472 to the WPIM 400. The WPIM 400 then transmits the access decision to the WAPM 300.

As mentioned above, the WPIM 400 includes a data port 430. The data port 430 is preferably an RS485 port. The data port 430 may be used, for example, by an operator to connect a computer to the WPIM 400 to perform various tasks, such as configuring the WPIM 400, for example. Some exemplary WPIM items for configuration include the transmission frequency for the communication link with the WAPM and the performance of the indicators 420.

Additionally, configuration information may be received by the data port 430 of the WPIM 400 and relayed to the WAPM 300 via the transceiver 460. The configuration information that is received by the WAPM 300 may then by relayed to the access/monitoring processor 350 of the WAPM 300 for implementation at the WAPM 300.

The WPIM may include several variations including a panel interface module (PIM) and a panel interface module expander (PIME). As mentioned above, a single PIM may communicate with multiple WAPMs. Additionally, the housing for the PIM is preferably constructed to allow additional PIM modules to be installed in the PIM housing to form the PIME. Because the PIME includes multiple PIM modules, the PIME may service more access points.

With regard to the WAPM 300 of FIG. 3, the WAPM 300 relies on the internal power supply 370, preferably a battery, to power its operations. Thus, the longevity of the power supply 370 during use is of great concern. In order to maximize the life of its battery, the WAPM attempts to consume the least amount of power necessary to sustain operation.

Preferably, the WAPM 300 includes a sleep state. In the sleep state, the transceiver 360 is turned off. That is, no power is supplied from the power supply 370 to the transceiver 360. When the transceiver 360 is turned off, communication between the WAPM 300 and the WPIM 400 does not occur. Consequently, the WAPM 300 controls the timing of communications between the WAPM 300 and the WPIM 400 because such communications may only occur when the transceiver 360 is not in a sleep state.

In contrast, the WPIM's transceiver 460 preferably remains on constantly in case the WAPM 300 needs to communicate with the WPIM 400. However, the WPIM is preferably directly wired to a power source, so consumption of power at the WPIM is typically not a concern.

The WAPM's sleep state saves a great deal of power and preserves the life of the power supply 370 because the transceiver 360 typically consumes a lot of power when active and the imposition of the sleep state means that power is only delivered to the transceiver 360 when the WAPM needs to communicate with the WPIM. Depending on the traffic through the WAPM, the use of the sleep state may reduce the total power consumption of the WAPM by 99% or more.

However, because the WAPM is not continuously communicating with the WPIM, an uncertainty arises as to whether the WAPM will be able to reestablish communication with the WPIM once the WAPM emerges from its sleep state. Preferably, the WAPM assumes that communication with the WPIM is still possible upon emerging from the sleep state and transmits a signal to the WPIM using the same channel that was last employed before the WAPM entered the sleep state. If the WAPM eventually is not able to communicate with the WPIM, the WAPM must re-link to the WPIM. The re-linking procedure is described in the co-pending application, Application No. ______, entitled “RF Channel Linking Method and System” filed Sep. 30, 2002. The present application details the procedure the WAPM uses when emerging from the sleep state assuming the WAPM eventually links to the WPIM and re-linking is not necessary.

In one embodiment of the present invention a retry protocol is employed to improve the successful data transfer rate when the WAPM emerges from the sleep state. The retry protocol starts with the WAPM. When the WAPM emerges from the sleep state and initiates a communication with the WPIM, the WAPM sends a data packet to the WPIM. Under normal communication conditions, the WPIM acknowledges the WAPM's transmission and responds immediately with a confirmation that the WAPM's signal has been received.

However, if the WPIM detects an error in the WAPM's data transmission, the WPIM preferably does not respond. If the WPIM does not respond within an anticipated time, then the WAPM retransmits the data packet to the WPIM. If the WPIM continues to not respond, the WAPM continues to attempt to retransmit to the WPIM. Preferably, the WAPM attempts to transmit at least three times, the original transmission attempt and two retransmission attempts. Additionally, preferably, the WAPM's attempts to retransmit are randomly spaced in time. Alternatively, the WAPM's attempts to retransmit may be spaced apart a predetermined amount of time, for example, 5 ms apart.

Additionally, if the WPIM does respond to the WAPM but the WPIM's response includes errors, then the WAPM preferably retransmits the original data packet to the WPIM in order to generate an error-free response. Again, as above, the WAPM preferably attempts to transmit three times, the original transmission attempt and two retransmission attempts.

Although the WAPM 300 preferably includes a sleep state during which the WAPM's transceiver is not powered, the WAPM also preferably wakes up periodically to test the integrity of the communication channel between the WAPM and the WPIM and to let the WPIM know that the WAPM is still active. The periodic transmission from the WAPM to the WPIM is called a heartbeat. During the heartbeat, the WAPM preferably identifies itself to the WPIM and the WPIM sends a confirmation to the WAPM that the WPIM has received the signal from the WAPM. If the heartbeat fails, the WAPM determined that the communication link between the WAPM and the WPIM is no longer valid and the WAPM initiates a re-linking procedure to re-link to the WPIM.

With regard to the heartbeat, the WAPM periodically sends a signal to the WPIM to confirm that the WAPM is still functioning. The heartbeat may be in addition to any access signal or trouble signal sent from the WAPM 300 to the WPIM 400. Alternatively, the heartbeat may initiate at a given time from the last access signal or other communication between the WAPM 300 and the WPIM 400.

If the WPIM does not receive a heartbeat signal from an WAPM for three heartbeat intervals, then the WPIM preferably reports the loss of the wireless heartbeat communication to the access control panel to alert an operator. Additionally, the WPIM preferably, indicates the problem through an indicator 420, such as an LED, for example.

The frequency of the heartbeat signal may be set by an operator. In a preferred embodiment of the present invention, the heartbeat is configurable from 15 seconds to 290 hours in 15 second intervals. Preferably, the heartbeat is commensurate with the application of the wireless system. For example, in a typical indoor installation, such as an office building a heartbeat of approximately 10 minutes may be employed.

Referring again to FIG. 2, an additional aspect of one embodiment of the invention may be observed. FIG. 2 illustrates a wireless access system 400 having a plurality of access points 290. Each access point 290 may be a portal such as a door, for example. Each access point 290 preferably is allocated an ID and an address data processor in the associated WAPM. As mentioned above, the ACP 210 preferably includes an access database.

As described above, each of the WAPMs includes a battery powered, wireless transceiver, containing an address identifying the particular access point 290. The WAPM sends and receives entrant and address identification data, from controlled access points of a building, enclosure, or other secured space to the access control panel 210. The entrant or identification data is the data submitted at the access point 290 to gain access. For example, card numbers, personal identification numbers (PINs), and the like.

The access control panel 210 includes a database of identification, address, and access information associated with system controlled access points and entrants. That is, the database lists the access points 290 and also preferably lists the individual users and whether they have access to a particular access point 290. The database may be stored on a peripheral device, such as a PC, for example. Additionally, the access control panel 210 may include a panel interface module transceiver to facilitate wireless communication to the distributed transceivers at the access points 290.

Preferably, during communication between the ACP 210 and the WAPMs, the communication takes place at the urging of the WAPMs rather than the ACP 210. That is, the WAPMs initiate communication with the ACP 210, with the WAPMs assuming the “master” role and the ACP 210 assuming the “slave” role in normal communications. That is, the ACP 210 preferably only transmits a return message after initiation of communication by the WAPM.

In one of the preferred embodiments of the present invention, the ACP 210 may transmit or broadcast a command to a number of access points 290 at once. For example, during an emergency evacuation of a building secured by the WAPMs at the access points 290, the ACP 210 may unlock all (or some subset) of the access points 290 at one time to provide immediate egress from the building. The signal unlocking the access points 290 may be in the form of a beacon signal that is continuously transmitted from the ACP 210 to the WAPMs access points 290. Alternatively, the signal unlocking the access points 290 may be transmitted continuously with a duty cycle of less than 100%. The broadcast command may activate only a subset of the access points 290 by optionally containing specific address information for the desired access points 290 in the broadcast command.

Because the WAPMs access points 290 are preferably powered down when not communicating with the ACP 210, the access points 290 preferably include a microprocessor that periodically provides power and activates the access points 290 to check for the broadcast command. That is, the microprocessor (within the battery powered distributed transceivers) causes the transceiver in the WAPM to power up periodically, at predetermined intervals, to check for the existence of a beacon signal command. The processor then determines if the broadcast command pertains to the WAPM at the specific access point 290 by comparing the address of the access point 290 to the addresses in the broadcast command. If the broadcast command is directed toward the specific access point 290, the access point executes the command, for example, unlocking the door. Additionally, the beacon transmitted by the ACP in an emergency situation may be encrypted so that the signal is more difficult to spoof or impersonate.

While particular elements, embodiments and applications of the present invention have been shown and described, it is understood that the invention is not limited thereto since modifications may be made by those skilled in the art, particularly in light of the foregoing teaching. It is therefore contemplated by the appended claims to cover such modifications and incorporate those features that come within the spirit and scope of the invention.

1. In an RF access control system, a method for reducing power consumption of a Wireless Access Point Module (WAPM) including a transceiver, said method comprising;
initiating access control communication from said WAPM; and
reducing the power supplied to said transceiver when said transceiver is not in use.

2. The method of claim 1 further including the step of periodically transmitting a heartbeat signal from said WAPM to a Wireless Panel Interface Module (WPIM).

3. The method of claim 2 further including the step of sending a confirmation from said WPIM to said WAPM when said WPIM receives said heartbeat signal.

4. The method of claim 3 wherein said confirmation is not sent from said WPIM to said WAPM if the heartbeat signal includes an error.

5. The method of claim 4 wherein said WAPM repeats said heartbeat signal after a predetermined time if no confirmation has been received by the WAPM.

6. The method of claim 5 further including the step of determining a communication link between said WAPM and WPIM to have failed after a predetermined number of heartbeats have been sent by said WAPM without a reply.

7. The method of claim 6 further including the step of initiating a re-linking procedure at said WAPM when said communication link has failed.

8. The method of claim 6 further including the step of the WPIM notifying an Access Control Panel (ACP) when said communication link has failed.

9. The method of claim 3 further including broadcasting an emergency beacon to a plurality of WAPMs to unlock said WAPMs.

10. The method of claim 9 wherein said emergency beacon includes an identifier identifying the WAPMs to unlock.

11. An RF access control system including:
a Wireless Access Point Module (WAPM) including a transceiver, wherein said WAPM reduces the power supplied to said receiver when said transceiver is not in use.

12. The system of claim 11 further including:
a Wireless Panel Interface Module (WPIM) wherein said WAPM periodically transmits a heartbeat signal to said WPIM.

13. The system of claim 12 wherein said WPIM sends a confirmation to said WAP< when said WPIM receives said heartbeat.

14. The system of claim 13 wherein WPIM does not send a confirmation to said WAPM if said heartbeat received by said WPIM includes an error.

15. The system of claim 14 wherein said WAPM repeats said heartbeat signal after a predetermined time if no confirmation has been received by the WAPM.

16. The system of claim 15 wherein said WPIM and said WAPM determine that the communication link between said WPIM and said WAPM has failed after a predetermined number of heartbeats have been sent by said WAPM without a reply.

17. The system of claim 16 wherein said WAPM initiates a re-linking procedure when said communication link has failed.

18. The system of claim 16 further including:
an Access Control Panel (ACP) wherein said WPIM notifies said ACP when said communication link has failed.

19. The system of claim 13 further including:
an Access Control Panel (ACP) ACP broadcasts an emergency beacon to a plurality of WAPMs to unlock said WAPMs.

20. The system of claim 19 wherein said emergency beacon includes an identifier identifying the WAPMs to unlock.
